(19) United States
(12) Patent Application Publication
(10) Pub. No.: US 2010/0148655 A1
(43) Pub. Date: Jun. 17, 2010

(54) LIGHT-EMITTING SUBSTRATE AND IMAGE DISPLAY APPARATUS

(75) Inventor: Koji Yamazaki, Ayase-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/624,791

(22) Filed: Nov. 24, 2009

(30) Foreign Application Priority Data
Dec. 16, 2008 (JP) 2008-319686

(51) Int. Cl. H01J 21/10

(52) U.S. Cl. 313/307

(57) ABSTRACT

A light-emitting substrate according to the present invention comprises a substrate, a plurality of light-emitting members disposed on the substrate, and a plurality of metal backs two-dimensionally arranged, the plurality of metal backs covering the plurality of light-emitting members. The metal backs in even-numbered rows and the metal backs in odd-numbered rows are disposed out of alignment with each other in a row direction, and the metal backs in even-numbered rows and in a same column are connected with one another by a first resistor, and the metal backs in odd-numbered rows and in a same column are connected with one another by a second resistor.

### BACKGROUND OF THE INVENTION

1. Field of the Invention

The present invention relates to a light-emitting substrate and an image display apparatus.

2. Description of the Related Art

An image display apparatus having a plurality of electron-emitting devices includes an electron source substrate and a light-emitting substrate. The electron source substrate includes a plurality of electron-emitting devices arranged in a matrix. The light-emitting substrate includes a plurality of light-emitting members that are arranged in a matrix and are provided opposite to the plurality of electron-emitting devices.

In such an image display apparatus, the distance between a light-emitting substrate and an electron source substrate is typically about several millimeters, and a high voltage of, for example, about 10 kV is applied between both the substrates. Specifically, in order to accelerate electrons emitted from electron-emitting devices to collide them with light-emitting members, a high voltage is applied to a single metal film called a metal back provided on the light-emitting members (a side of the electron-emitting devices). Therefore, discharge easily occurs between the light-emitting substrate and the electron source substrate. When discharge occurs, charges stored in the metal back flow into the electron source substrate. As a result, destruction of the electron-emitting devices and destruction of circuits (such as melting of wires) might occur. There is a potential that an image cannot be displayed.

Conventional techniques in view of such a problem, that is, conventional techniques for suppressing the flow of charges due to discharge (discharge current) (for providing a discharge current suppression function to an image display apparatus) are discussed, for example, in Japanese Patent Application Laid-Open No. 2006-120622. Specifically, Japanese Patent Application Laid-Open No. 2006-120622 discloses a configuration in which a metal back is divided into a matrix, and the divided metal backs (metal backs adjacent to one another in the column direction) are connected by a strip-shaped resistor extending in the column direction (discharge-withstand structure). Such a configuration can decrease the area per metal back as compared to a conventional configuration. That is, the amount of charges that can be stored per metal back can be decreased, and therefore discharge current can be suppressed (decreased).

With such a configuration as disclosed in Japanese Patent Application Laid-Open No. 2006-120622, however, if discharge occurs between an electron source substrate and a light-emitting substrate (inter-substrate discharge), the potential difference between a metal back in an area where the discharge occurs and the adjacent metal back becomes large. Therefore, there is a potential of causing discharge (secondary discharge) between the metal backs. Moreover, there is a desire for a higher voltage applied to metal backs for the improvement in luminance. However, as the voltage applied to metal backs is higher, the potential difference between metal backs upon inter-substrate discharge is larger. As a result, secondary discharge easily occurs.

Moreover, depending on the material of a resistor, the withstand voltage of the resistor is lower than the creeping withstand voltage between adjacent metal backs. There is a potential of causing destruction of the discharge-withstand structure.

### SUMMARY OF THE INVENTION

In view of the circumstances, it is an object of the present invention to provide a technique for suppressing discharge that occurs between an electron source substrate and a light-emitting substrate and discharge that occurs between metal backs.

A light-emitting substrate according to the present invention, comprising:

a substrate;

a plurality of light-emitting members disposed on the substrate; and

a plurality of metal backs two-dimensionally arranged, the plurality of metal backs covering the plurality of light-emitting members, wherein

the metal backs in even-numbered rows and the metal backs in odd-numbered rows are disposed out of alignment with each other in a row direction, and

the metal backs in even-numbered rows and in a same column are connected with one another by a first resistor, and the metal backs in odd-numbered rows and in a same column are connected with one another by a second resistor.

An image display apparatus according to the present invention, comprising:

the light-emitting substrate and

an electron source substrate having an electron-emitting device, disposed opposite to a light-emitting member side of the light-emitting substrate.

According to the present invention, it is possible to provide a technique for suppressing discharge that occurs between an electron source substrate and a light-emitting substrate and discharge that occurs between metal backs.

Further features of the present invention will become apparent from the following description of exemplary embodiments with reference to the attached drawings.

### BRIEF DESCRIPTION OF THE DRAWINGS

FIG. 1 is a plan view of a light-emitting substrate according to a first embodiment.

FIG. 2 is a cross-sectional view taken along the line A-A′ in FIG. 1.

FIG. 3 illustrates an example where phosphor is colored in the form of stripes.

FIG. 4 is a plan view of a light-emitting substrate according to a second embodiment.

FIG. 5 is a cross-sectional view taken along the line V-V in FIG. 4.

FIG. 6 is a plan view of a light-emitting substrate according to a third embodiment.

FIG. 7 is a partially cutaway perspective view of an image display apparatus using a light-emitting substrate according to the first to third embodiments.

FIG. 8 illustrates an example of the setting mode of metal backs.

FIG. 9 illustrates an example of the setting mode of metal backs.

FIG. 10 illustrates an example of the setting mode of metal backs.

### DESCRIPTION OF THE EMBODIMENTS

Embodiments of the present invention will be described below.

A light-emitting substrate according to the present embodiments can be applied to a face plate for an electron beam display device. For example, it can be applied to face plates for cathode-ray tube (CRT) displays and field emission displays (FED). In an FED, since the beam diameter can be easily narrowed, its color reproducibility can be remarkably improved by reducing the halation. Further, in the FED, since a high electric field is formed between an electron source substrate and a light-emitting substrate (between a cathode and an anode), there is a need for a discharge-withstand capability (discharge-withstand structure) with which an image displaying capability does not deteriorate in the event of occurrence of discharge. Therefore, a faceplate for an FED is a preferred embodiment to which a light-emitting substrate according to the present embodiments is applied. In the present embodiments, description is given for the case where a light-emitting substrate is a face plate for an FED, specifically a face plate for an image apparatus display using surface-conduction electron-emitting devices.

### First Embodiment

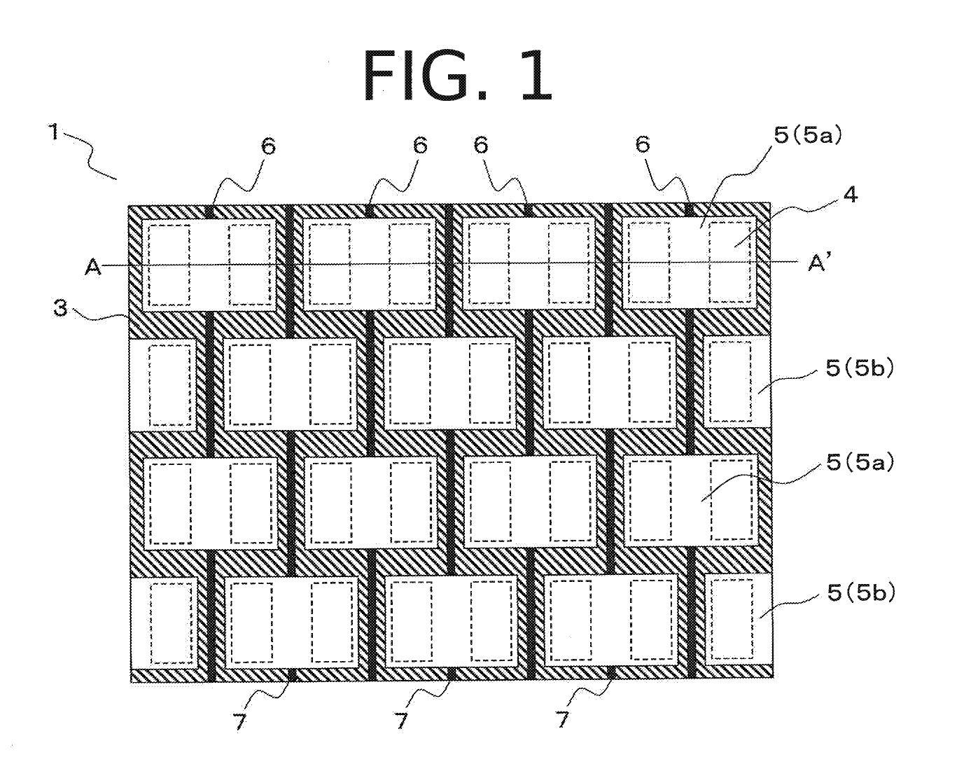

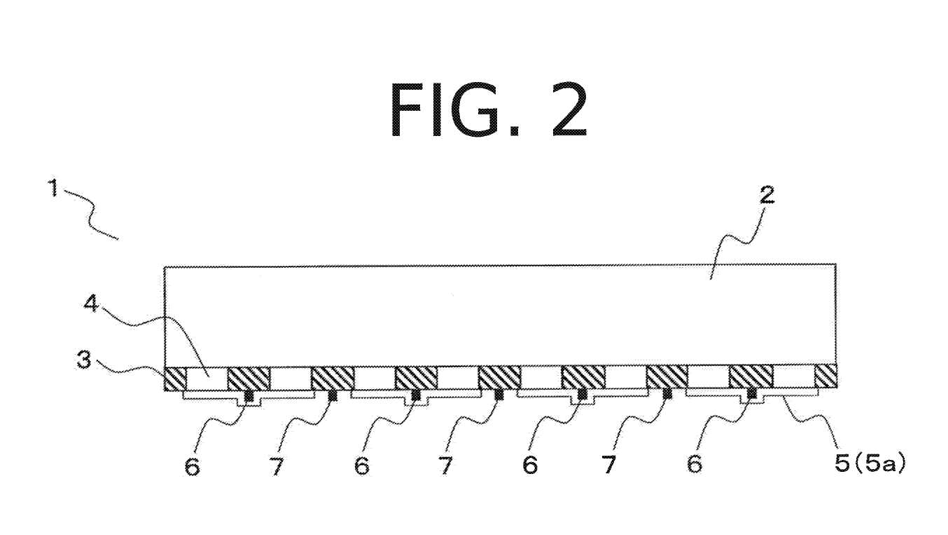

FIG. 1 is a plan view of a light-emitting substrate according to a first embodiment, and FIG. 2 is a cross-sectional view taken along the line A-A′ in FIG. 1. As illustrated in FIGS. 1 and 2, the light-emitting substrate 1 has a substrate 2, a black member 3, light-emitting members 4, metal backs 5, resistors 6 and resistors 7.

In an electron beam display device, a vacuum state is maintained between an electron source substrate and a light-emitting substrate (between a face plate and a rear plate). It is preferable to use a glass substrate as the substrate 2 because sufficient strength can be ensured and the vacuum state between the electron source substrate and the light-emitting substrate can be kept.

The black member 3 is formed on the substrate 2. The black member 3 has a plurality of openings. In the present embodiment, the black member 3 is formed in a grid pattern. That is, openings of the black member 3 are arranged in a matrix. The black member 3 is used for reasons, such as preventing mixture (color mixture) of emitted light of a plurality of light-emitting members 4 to be described later.

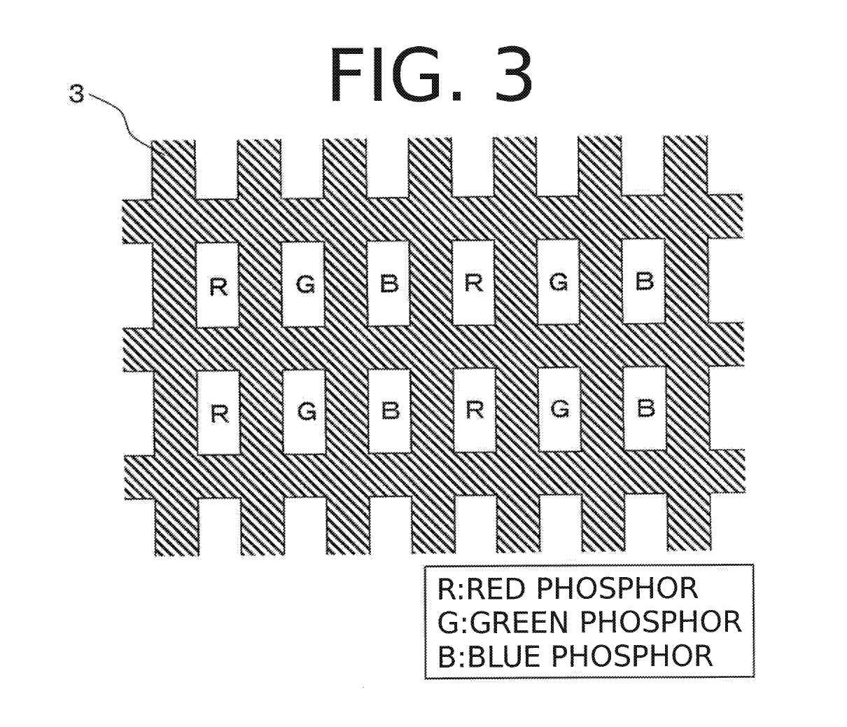

Formed in the openings of the black member 3 is phosphor as the light-emitting members 4. That is, the plurality of light-emitting members 4 is disposed on a substrate (on the substrate 2). In the present embodiment, since the openings of the black member 3 are arranged in a matrix, the light-emitting members 4 are also arranged in a matrix. In color display, the plurality of light-emitting members 4 is made into different colors, R, G and B. The pattern of making the light-emitting members 4 may be appropriately determined according to display characteristics, and is not particularly limited. FIG. 3 illustrates an example of the case where phosphor is colored in the form of stripes (the case where phosphor is colored differently such that its light emission characteristic differs for every column).

A plurality of metal backs 5 are two-dimensionally (matrix) arranged on a layer including the plurality of light-emitting members 4 and the black member 3. Each metal back 5 is provided so as to cover two or more light-emitting members 4 in the row direction such that all the light-emitting members 4 are covered with all the metal backs 5. Covering all the light-emitting members with the plurality of metal backs 5 can suppress discharge current even if discharge occurs between an electron source substrate and a light-emitting substrate as compared to the case where covering all light-emitting members with a single metal back. Note that in the example of FIGS. 1 and 2, each metal back 5 is provided so as to cover two light-emitting members 4 in the row direction and one light-emitting member 4 in the column direction.

The metal backs 5 can be formed by masking a member for film formation before film formation to form a pattern or by etching a film after film formation to pattern the film when film formation is performed using a known film formation method. By a method of forming a film after masking, the metal backs 5 can be easily formed. Examples of the known film formation method include a deposition method. As the metal backs 5, for example, light metal such as aluminum may be used.

Further, regarding the plurality of metal backs 5 in the present embodiment, metal backs 5a in odd-numbered rows and metal backs 5b in even-numbered rows are disposed out of alignment with each other in the row direction. In the example of FIGS. 1 and 2, the metal backs 5a and the metal backs 5b are out of alignment with each other by a sub-pixel (by one light-emitting member) in the row direction. This is because if they are out of alignment with each other by two light-emitting members, the amount of misalignment of the metal backs 5a and the metal backs 5b is zero.

Resistors 6 and 7 connect the plurality of metal backs 5 in the column direction. Specifically, the resistor 6 connects metal backs in odd-numbered rows and in the same column (the metal backs 5a in the same column) with one another, and the resistor 7 connects metal backs in even-numbered rows and in the same column (the metal backs 5b in the same column) with one another. Accordingly, the resistor 6 is referred to as an odd resistor, and the resistor 7 as an even resistor.

In the present embodiment, as described above, the metal backs 5a and the metal backs 5b are disposed out of alignment with each other in the row direction. The metal backs 5a in the same column or the metal backs 5b in the same column can therefore be easily connected by a resistor. For example, since the metal backs 5a and the metal backs 5b are disposed out of alignment with each other in the row direction, a resistor can be provided so as to pass through a gap between two metal backs that are positioned between metal backs connected with each other by the resistor. Specifically, the odd resistor 6 can be provided so as to pass through a gap (of course, a gap in the row direction) between the metal backs 5b that are positioned between the metal backs 5a connected with each other by the odd resistor 6. The setting mode of the even resistor 7 (the mode in which the even resistor 7 connects the metal backs 5b) is the same as that of the odd resistor 6, and therefore description for it will not be given.

The odd resistor 6 and the even resistor 7 can be formed by known processing methods such as pattern printing and dispenser. Note that it is preferable to form the resistors by pattern printing in terms of accuracy and productivity.

As described above, in the light-emitting substrate according to the present embodiment, metal backs in odd-numbered rows and in the same column are connected with one another by a resistor, and metal backs in even-numbered rows and in the same column are connected to one another by a resistor. This enables the length of a resistor between the metal backs 5 to be longer than that of a conventional resistor (greater than twice the length of a conventional resistor). If discharge occurs between an electron source substrate and a light-emitting substrate, the potential distribution between a metal back in an area where discharge occurs and the adjacent metal back becomes broad. Therefore, a resistor can be prevented from destruction. This can lead to prevention against secondary discharge. It thus becomes possible to apply a higher potential (anode potential) than a conventional one to metal backs.

### Second Embodiment

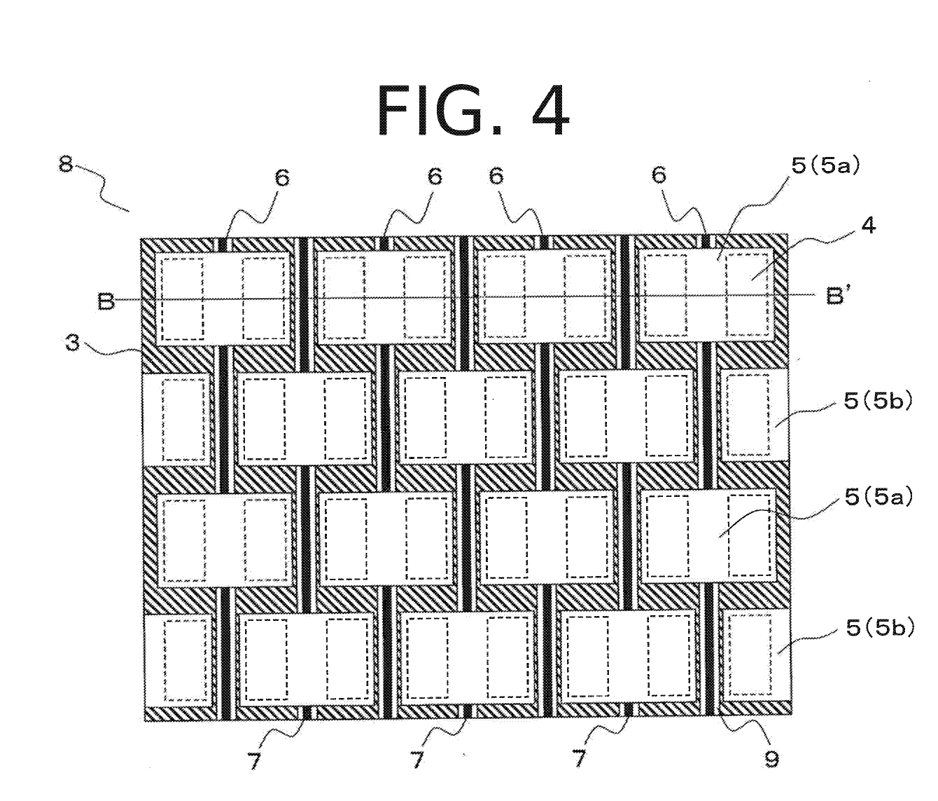

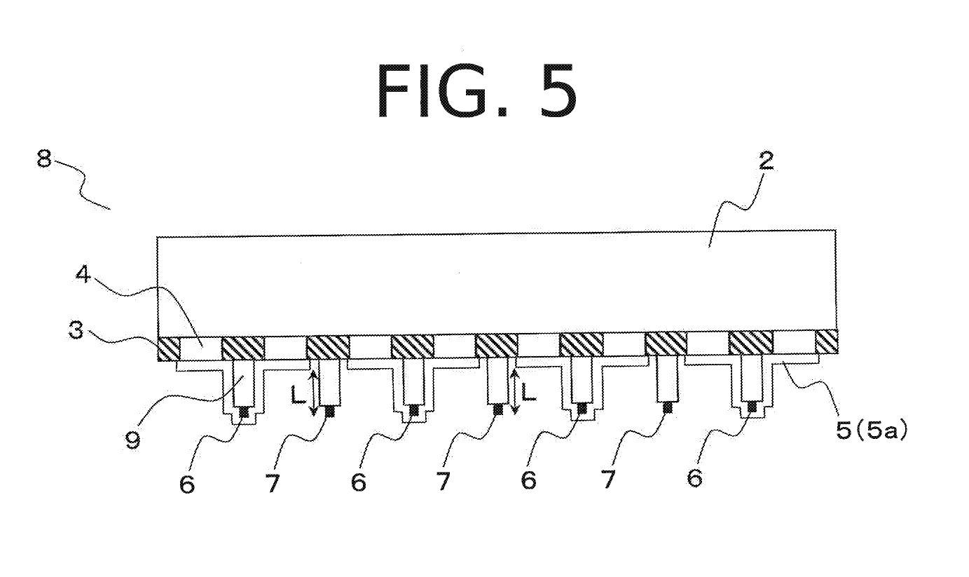

In a second embodiment, description is given to a configuration in which a light-emitting substrate is provided with ribs for reducing halation. FIG. 4 is a plan view of a light-emitting substrate 8 according to the second embodiment, and FIG. 5 is a cross-sectional view taken along the line B-B′ in FIG. 4. As illustrated in FIGS. 4 and 5, the light-emitting substrate 8 according to the present embodiment further includes ribs 9 in addition to the configuration illustrated in FIGS. 1 and 2. Note that in FIGS. 4 and 5, members identical or equivalent to those illustrated in FIGS. 1 and 2 are denoted by the same reference numerals.

The ribs 9 are provided at least on a pattern extending in the column direction in the black member 3. That is, the ribs 9 are provided so as to pass between light-emitting members adjacent to each other in the row direction, and resistors are provided on the ribs 9. For example, the resistors 6 and 7 are formed on the ribs by pattern printing. The height of the rib 9 is appropriately selected based on the pixel size and the anode voltage. The rib 9 can be formed by known processing methods, such as lamination of pattern printing, blasting of a thick film, and slit coating. Note that formation by blast processing is preferable in terms of accuracy, productivity and suitability for a large area.

As described above, in a light-emitting substrate according to the present embodiment, a resistor is provided so as to pass on a rib. This can lengthen a creeping distance (L in FIG. 5) between the resistor and metal backs forming a gap through which the resistor passes (providing a rib allows the creeping distance to be longer in the height direction of the rib). Thus, withstand voltage between a resistor and two metal backs that are positioned between metal backs connected with each other by the resistor can be increased, enabling a higher anode voltage than that in the first embodiment to be applied to metal backs.

### Third Embodiment

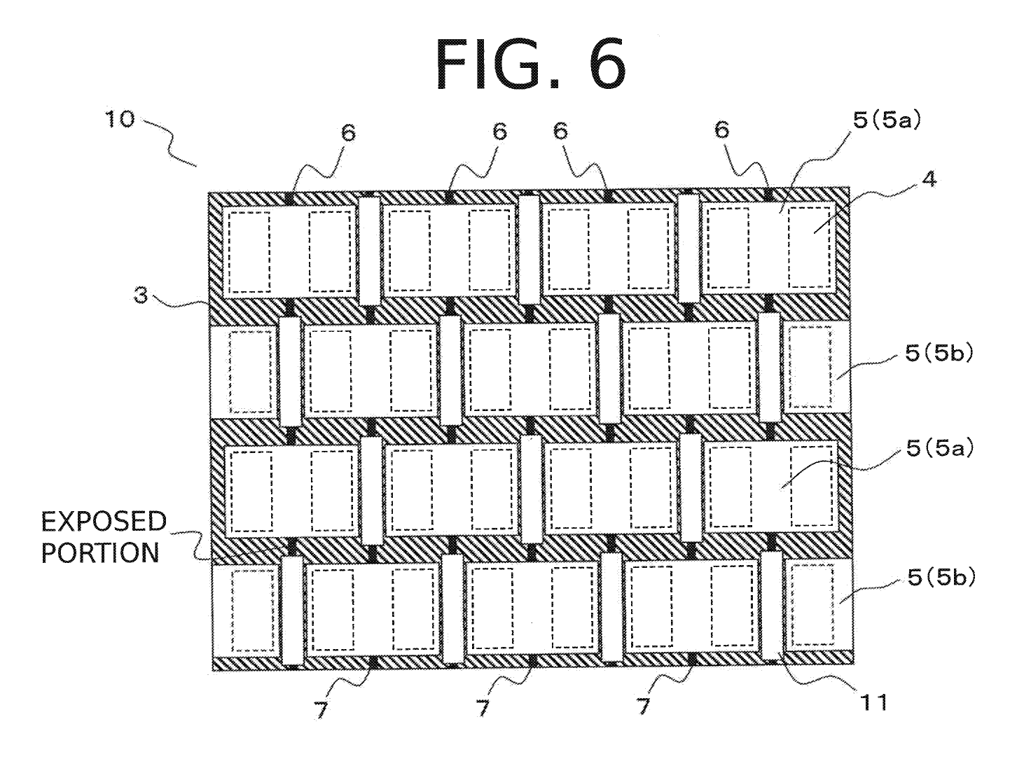

In a third embodiment, description is given to a configuration in which a light-emitting substrate further includes a high-resistance member (a cover member 11 of FIG. 6) covering a portion (gap portion) of a resistor that passes through a gap between two metal backs that are positioned between metal backs connected with each other by the resistor. FIG. 6 is a plan view of a light-emitting substrate 10 according to the third embodiment.

The cover member 11 is a member having a higher resistance than those of the resistors 6 and 7.

As described above, a light-emitting substrate according to the present embodiment further includes a high-resistance member that covers a gap portion of a resistor and has a higher resistance than that of the resistor. Thus, the withstand voltage between a resistor and two metal backs that are positioned between metal backs connected with each other by the resistor can be increased, enabling a higher anode voltage than that in the first embodiment to be applied to metal backs.

Note that it is preferable that the shortest distance between a portion that is not covered with a high-resistance member of a resistor (exposed portion) and metal backs forming a gap through which the resistor passes be longer than the width of the gap through which the resistor passes. With such a configuration, the withstand voltage between a resistor and two metal backs that are positioned between metal backs connected with each other by the resistor can be increased, enabling a higher anode voltage than that in the first embodiment to be applied to metal backs.

### <Modification>

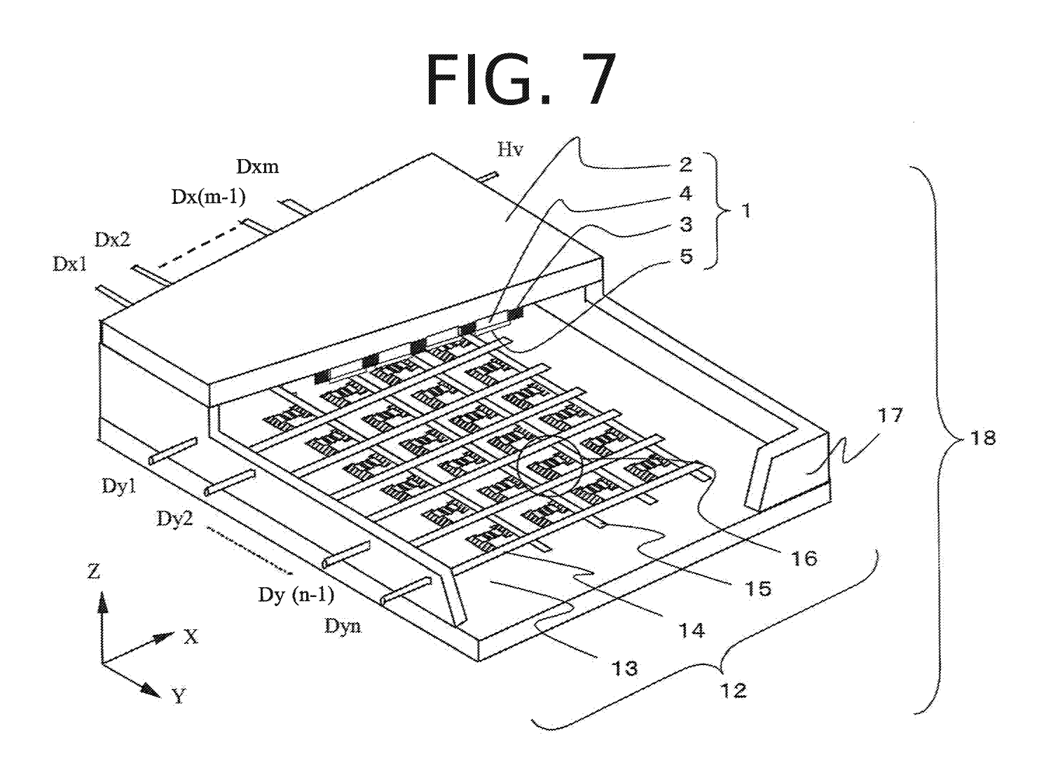

As modifications, an image display apparatus using a light-emitting substrate according to the first to third embodiments is described below. FIG. 7 is a partially cutaway perspective view of an image display apparatus (FED) using a light-emitting substrate (face plate) according to the first to third embodiments. In FIG. 7, reference numeral 13 denotes a glass substrate; reference numeral 14 denotes a scanning wire; reference numeral 15 denotes a signal wire; and reference numeral 16 denotes an electron-emitting device (surface-conduction electron-emitting device). These form a rear plate 12 (electron source substrate). The rear plate 12 is provided so that electron-emitting devices are disposed opposite to the face plate (a light-emitting member side of the light-emitting substrate).

N scanning wires 14, M signal wires 15 and N×M electron-emitting devices 16 are formed on the glass substrate 13. N×M electron-emitting devices 16 are wired in a matrix of N scanning wires 14 and M signal wires 15. Note that N and M are positive integers, and are appropriately set according to the desired number of displayed pixels. For example, in the case for the purpose of full high definition (FHD), N is 1080 and M is 1920×3=5760

In FIG. 7, reference numeral 17 denotes an outer frame, and a vacuum container 18 (display panel) includes the outer frame 17, the face plate 1 (light-emitting substrate) and the rear plate 12. Depending on the size of the vacuum container 18, a spacer (not illustrated) for atmospheric pressure supporting is sometimes disposed between the face plate and the rear plate.

By connecting a power supply, driving circuit and the like, which are not illustrated, to the vacuum container 18, an image display apparatus is formed. Briefly described, a plurality of metal backs 5 (common wiring in which the resistors 6 and 7 connected to the plurality of metal backs 5 are brought together) are electrically connected to an Hv terminal of the vacuum container 18, and an anode voltage in the range from about 1 to 15 kV is applied to a plurality of metal backs 5. The scanning wire 14 and the signal wire 15 are electrically connected respectively to a terminal Dyn (n is in the range from 1 to N) and a terminal Dxm (m is in the range from 1 to M) of the vacuum container 18. A scanning signal and an image signal are provided from the driving circuit to the scanning wire 14 and the signal wire 15, respectively.

The electron-emitting device 16 emits electrons whose amount is dependent on the scanning signal and the image signal. By applying a high voltage to the metal backs 5, the emitted electrons are drawn to the metal backs (accelerate toward the metal back), go through the metal backs, and collide with phosphor. This collision causes the phosphor to emit light, so that an image is illustrated on a display panel. The luminance can be adjusted by the use of an anode voltage and signals (a scanning signal and an image signal).

The above-described image display apparatus includes a light-emitting substrate according to the first to third embodiments, as a face plate. In the light-emitting substrate according to the first to third embodiments, increasing the anode voltage while maintaining the discharge-withstand capability (capability of suppressing occurrence of discharge) is possible as described above. Therefore, it becomes possible to provide an image display apparatus that is excellent in discharge-withstand capability and whose luminance is high.

### EXAMPLES

Specific examples of a light-emitting substrate according to the present embodiments and an image display apparatus are described in detail below.

### Example 1

In the present example, a specific example of a light-emitting substrate illustrated in FIG. 6 and an image display apparatus illustrated in FIG. 7 is described. FIG. 6 is a plan view of a light-emitting substrate (faceplate), and FIG. 7 is a partially cutaway perspective view of an image display apparatus using the face plate. Note that in FIG. 7, part (a power supply, a driving circuit and the like) of the configuration required for the image display apparatus will not be described.

A method of manufacturing the face plate 10 of the present example is described below.

First, a black paste (NP-7803D made by Noritake Co., Limited) was printed in a grid pattern on the cleaned surface of a glass substrate by screen printing, and then was dried at 120° C. and thereafter was fired at 550° C., thereby forming the black member 3 of 5 μm in thickness. The pitches of openings were set to the same as those of electron-emitting devices on a rear plate. Specifically, the pitch in the Y direction (column direction) was set as 600 μm, and the pitch in the X direction (row direction) as 200 μm. Regarding the size of an opening, the length in the Y direction was set as 360 μm, and the length in the X direction as 100 μm.

Next, a high-resistance paste in which ruthenium oxide was contained was printed on the black member 3, specifically on patterns extending in the column direction (between openings adjacent to each other in the row direction) in the black member 3, by screen printing, and then was dried at 120° C. for ten minutes. These were fired at 530° C., thereby forming resistors (the odd resistors 6 and the even resistors 7) in the form of stripes extending in the column direction. Note that the film thickness after printing was adjusted so that the film thickness after firing was 5 μm. When this high-resistance paste was applied to a test pattern and the resistance value after firing was measured, the volume resistance was about 10⁻¹Ω·m. The width of the resistor in the row direction was set as 40 μm.

Then, pattern printing of a glass paste containing no conductive particle was performed so that the glass paste covered both portions passing between openings of the black member 3 positioned in even-numbered rows in the odd resistors 6 and portions passing between openings of the black member 3 positioned in odd-numbered rows in the even resistors 7. The glass pattern was fired, thereby forming the cover members 11. The width of the cover member 11 in the row direction was set as 60 μm so as not to expose a resistor. The width of the cover member 11 in the column direction was set as 560 μm.

Next, as the light-emitting members 4, a paste containing P22 phosphor, which is used in the field of CRT, dispersed therein was printed according to openings of the black member 3 by screen printing. In the present example, phosphor in three colors of RGB was individually pasted in the form of stripes in three colors so as to achieve color display. The film thickness of each phosphor was set as 15 μm. After the phosphor in three colors was printed, it was dried at 120° C. Note that drying may be performed individually for each color, and may also be performed simultaneously for three colors. An aqueous solution containing an alkali silicate, so-called water glass, which acted as a binding material after being dried, was applied by spraying. Then, an acrylic emulsion was applied by a spray coating method and was dried to fill a gap of a phosphor powder with acrylic resin.

An aluminum film to be the metal backs 5 was deposited so as to cover the light-emitting members 4. Finally; acrylic resin filled in the gap of the phosphor powder was decomposed and removed by heating it at 450° C. The aluminum film thickness was set as 100 nm.

The plurality of metal backs 5 were formed so that one metal back covered two sub-pixels adjacent to each other in the row direction. The plurality of metal backs 5 divided in island shapes were arranged in a matrix, and deposition was performed using a metal mask so that their odd-numbered rows and even-numbered rows were in a pattern in which each odd-numbered row was out of alignment with each even-numbered row by one sub-pixel. As a result, the metal backs 5 were disposed in a staggered configuration. The width of each metal back in the row direction was set as 310 μm, and the width in the column direction as 380 μm.

Note that the face plate 10 was provided with a high-voltage introduction terminal that penetrated the face plate 10 through a through hole. The odd resistors 6 and the even resistors 7 extending outside an area for displaying an image were connected to the high-voltage introduction terminal (not illustrated).

Using the face plate 10 manufactured as mentioned above, an image display apparatus as illustrated in FIG. 7 was manufactured. In the manufactured image display apparatus, a voltage of 10 kV was applied through the odd resistor 6 and the even resistor 7 to the metal backs 5. By applying an excessive voltage to a particular electron-emitting device, the discharge-withstand capability (discharge current suppressing capability) upon destruction of the element was checked. As a result, no sign of the secondary discharge in the column direction was observed, and there was no increase in discharge current. No abnormality was observed in peripheral elements other than the element intentionally destroyed.

Further, the image display apparatus was taken apart, and the internal surface of the face plate 10 was observed. However, no damage to the odd resistors 6 and the even resistors 7 was observed in the vicinity of a place where element discharge (discharge between the face plate and the rear plate) was induced.

### Example 2

In the present example, a specific example of the light-emitting substrate illustrated in FIGS. 4 and 5 and the image display apparatus illustrated in FIG. 7 is described. FIG. 4 is a plan view of a light-emitting substrate (face plate), FIG. 5 is a cross-sectional view taken along the line B-B′ of FIG. 4, and FIG. 7 is a partially cutaway perspective view of an image display apparatus using the face plate. Note that in FIG. 7, part (a power supply, a driving circuit and the like) of the configuration required for the image display apparatus will not be described.

A method of manufacturing the face plate 8 of the present example is described below.

First, a black paste (NP-7803D made by Noritake Co., Limited) was printed in a grid pattern on the cleaned surface of a glass substrate by screen printing, and then was dried at 120° C. and thereafter was fired at 550° C., thereby forming the black member 3 of 5 μm in thickness. The pitches of openings were set to the same as those of electron-emitting devices on a rear plate. Specifically, the pitch in the Y direction (column direction) was set as 450 μm, and the pitch in the X direction (row direction) as 150 μm. Regarding the size of an opening, the length in the Y direction was set as 220 μm, and the length in the X direction as 90 μm.

Next, a bismuth oxide insulating paste (NP7753 made by Noritake Co., Limited), which finally resulted in the ribs 9, was applied by a slit coater so that the film thickness after firing was 190 μm, and was dried at 120° C. for 10 minutes.

In order to be laminated on this (the bismuth oxide insulating paste), a high-resistance paste in which ruthenium oxide is contained was formed by a screen printing method so that the film thickness after firing was 10 μm, and was dried at 120° C. for 10 minutes. A high-resistance layer (the high-resistance paste) was printed over the whole image display area in the present example; however, pattern printing may be performed so as to create a shape containing just a portion remaining after sandblasting to be described later. When a material used for this high-resistance layer was applied to a test pattern and the resistance value after firing was measured, the volume resistance was about 10⁻¹Ω·m.

Next, a dry film resist (DFR) was attached onto the high-resistance paste by the use of a laminator. Further, an exposure chrome mask was aligned with a given position, and pattern exposure of the DFR was performed. The alignment was performed by using an alignment mark (now illustrated) provided outside an area for displaying an image. A pattern to be exposed was in the form of stripes of 60 μm wide in the column direction such that the pattern overlapped the black member 3. That is, exposure was performed over patterns extending in the column direction in the black member 3. Showering processes of a developer of the DFR and a rinse and drying were performed to form a mask for sandblasting. Thereafter, the high-resistance paste and an insulation paste of a portion that was not masked with the DFR were removed by sandblasting (method) using grains of SUS as abrasive grains, and the DFR was stripped by showering of a stripping liquid. Then, cleaning and firing at 530° C. were performed, thereby forming the ribs 9, the odd resistors 6 and the even resistors 7.

Next, using a paste containing P22 phosphor, which is used in the field of CRT, dispersed therein, phosphor was dropped as the light-emitting members 4 into openings according to the openings of the black member 3 (and the ribs 9) by a screen printing method. In the present example, phosphor in three colors of RGB was individually pasted in the form of stripes in three colors so as to achieve color display. The film thickness of each phosphor was set as 15 μm. After the phosphor in three colors was printed, it was dried at 120° C. Note that drying may be performed individually for each color, and may also be performed simultaneously for three colors. An aqueous solution containing an alkali silicate, so-called water glass, which acted as a binding material after being dried, was applied by spraying. Then, an acrylic emulsion was applied by a spray coating method and was dried to fill a gap of a phosphor powder with acrylic resin.

An aluminum film to be the metal backs 5 was deposited so as to cover the light-emitting members 4. Finally, acrylic resin filled in the gap of the phosphor powder was decomposed and removed by heating it at 450° C. The aluminum film thickness was set as 100 nm.

The plurality of metal backs 5 were formed so that one metal back covered two sub-pixels adjacent to each other in the row direction. The plurality of metal backs 5 divided in island shapes were arranged in a matrix, and deposition was performed using a metal mask so that their odd-numbered rows and even-numbered rows were in a pattern in which each odd-numbered row was out of alignment with each even-numbered row by one sub-pixel. Note that oblique deposition was performed from two directions so that the metal back 5 was formed on both side surfaces of the rib 9 between two sub-pixels. As a result, the metal backs 5 were disposed in a staggered configuration. The width of each metal back in the row direction was set as 240 μm, and the width in the column direction as 240 μm.

Note that the face plate 8 was provided with a high-voltage introduction terminal that penetrated the face plate 8 through a through hole. The odd resistors 6 and the even resistors 7 extending outside an area for displaying an image were connected to the high-voltage introduction terminal (not illustrated).

Using the face plate 8 manufactured as mentioned above, an image display apparatus as illustrated in FIG. 7 was manufactured. In the manufactured image di splay apparatus, a voltage of 12 kV was applied through the odd resistor 6 and the even resistor 7 to the metal backs 5. By applying an excessive voltage to a particular electron-emitting device, the discharge-withstand capability (discharge current suppressing capability) upon destruction of the element was checked. As a result, no sign of the secondary discharge in the column direction was observed, and there was no increase in discharge current. No abnormality was observed in peripheral elements other than the element intentionally destroyed.

Further, the image display apparatus was taken apart, and the internal surface of the face plate 8 was observed. However, no damage to the odd resistors 6 and the even resistors 7 was observed in the vicinity of a place where element discharge (discharge between the face plate and the rear plate) was induced.

As described above, with a light-emitting substrate and an image display apparatus according to the present embodiments, a metal back layer includes a plurality of metal backs, enabling suppression of discharge that occurs between an electron source substrate and a light-emitting substrate. Further, with a light-emitting substrate and an image display apparatus according to the present embodiments, the length of a resistor in the column direction can be increased, and therefore discharge occurring between metal backs can be suppressed. This enables applying of a higher voltage to metal backs, allowing luminance of a displayed image to be improved.

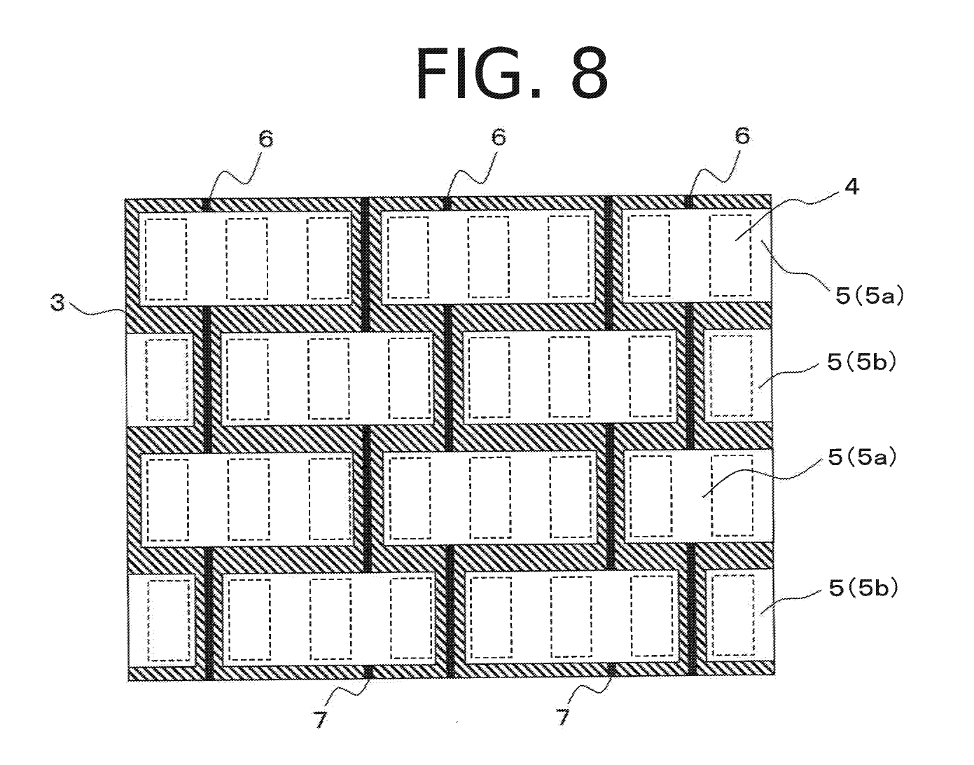

It should be noted that while description has been given to the case where each metal back is provided so as to cover two light-emitting members in the row direction and one light-emitting member in the column direction in the present embodiments, the number of light-emitting members covered by each metal back is not limited to these numbers. While description has also been given to the case where metal backs in odd-numbered rows and metal backs in even-numbered rows are out of alignment with each other by one light-emitting member in the row direction in the embodiments, the amount of misalignment between the metal backs in odd-numbered rows and the metal backs in even-numbered rows is not limited to this. Each metal back may be provided so as to cover two or more light-emitting members 4 arranged in the row direction. The amount of misalignment between the metal backs in odd-numbered rows and the metal backs in even-numbered rows may be smaller than the number of light-emitting members in the row direction covered by each metal back. For example, each metal back may be provided as illustrated in FIGS. 8 to 10.

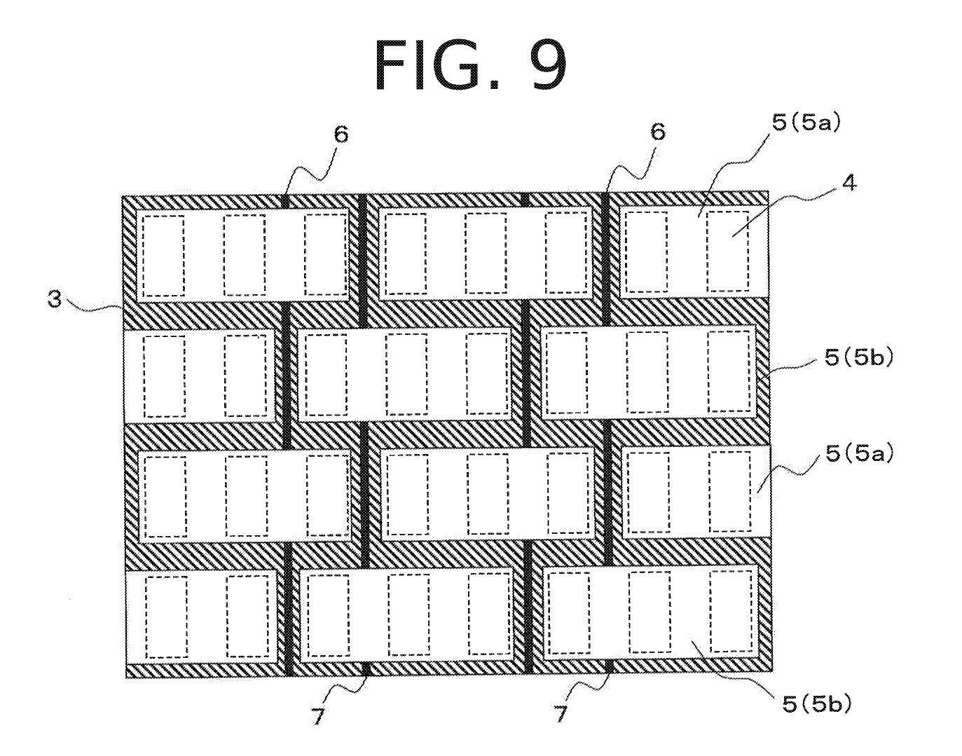

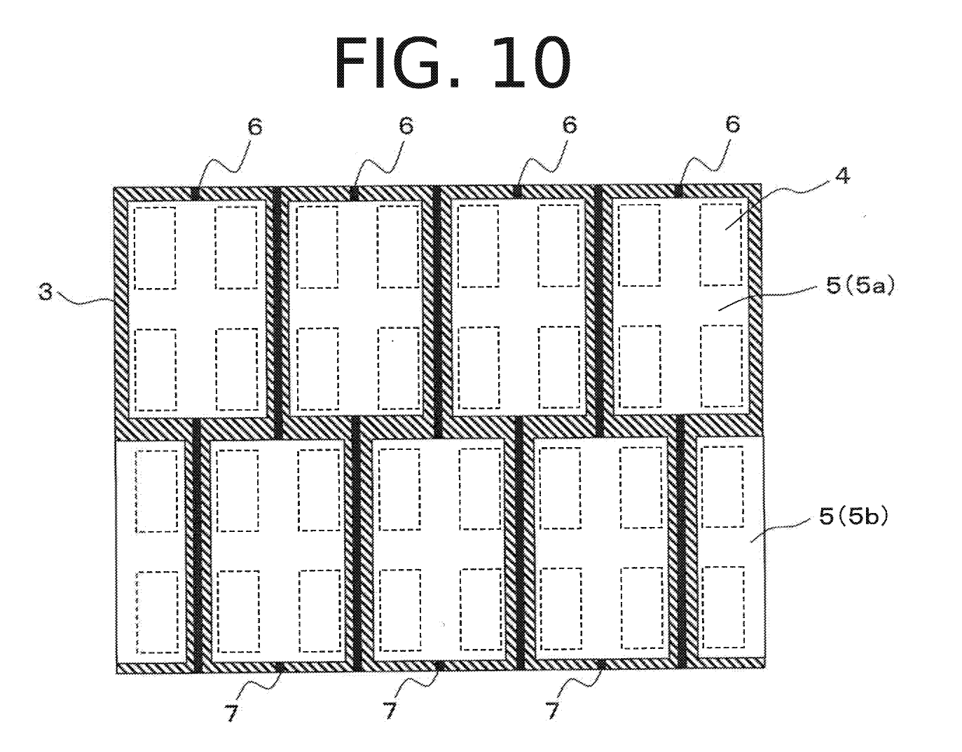

FIG. 8 is a schematic view illustrating the case where each metal back is provided so as to cover three light-emitting members in the row direction and one light-emitting member in the column direction, and metal backs in odd-numbered rows and metal backs in even-numbered rows are out of alignment with each other by one light-emitting member in the row direction. FIG. 9 is a schematic view illustrating the case where each metal back is provided so as to cover three light-emitting members in the row direction and one light-emitting member in the column direction, and metal backs in odd-numbered rows and metal backs in even-numbered rows are out of alignment with each other by two light-emitting members in the row direction. FIG. 10 is a schematic view illustrating the case where each metal back is provided so as to cover two light-emitting members in the row direction and two light-emitting members in the column direction, and metal backs in odd-numbered rows and metal backs in even-numbered rows are out of alignment with each other by one light-emitting member in the row direction.

It should be noted that while the lateral direction of a face plate (the lateral direction of a surface on which an image is displayed) is set as the row direction, and its vertical direction is set as the column direction in the present embodiments, the row direction and the column direction may be any directions. For example, lateral direction of the face plate may be set as the column direction, and its vertical direction may be set as the row direction. Each direction may be an inclined direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-319686, filed on Dec. 16, 2008, which is hereby incorporated by reference herein in its entirety.

What is claimed is:

1. A light-emitting substrate, comprising:
a substrate;
a plurality of light-emitting members disposed on the substrate; and
a plurality of metal backs two-dimensionally arranged, the plurality of metal backs covering the plurality of light-emitting members, wherein
the metal backs in even-numbered rows and the metal backs in odd-numbered rows are disposed out of alignment with each other in a row direction, and
the metal backs in even-numbered rows and in a same column are connected with one another by a first resistor, and the metal backs in odd-numbered rows and in a same column are connected with one another by a second resistor.

2. A light-emitting substrate according to claim 1, wherein each of the resistors is provided to pass through a gap between two of the metal backs that are positioned between the metal backs connected with each other by the each of the resistors.

3. A light-emitting substrate according to claim 2, further comprising a rib passing between the light-emitting members adjacent to each other in the row direction,
wherein each of the resistors is provided on the rib.

4. A light-emitting substrate according to claim 2, further comprising a high-resistance member having a resistance higher than a resistance of each of the resistors, the high-resistance member covering a portion of each of the resistors that passes through the gap between the two of the metal backs.

5. A light-emitting substrate according to claim 4, wherein a shortest distance between an exposed portion of each of the resistors without being covered with the high-resistance member and the metal backs forming the gap through which the each of the resistors passes is longer than a width of the gap through which the each of the resistors passes.

6. An image display apparatus, comprising:
the light-emitting substrate according to claim 1 and
an electron source substrate having an electron-emitting device, disposed opposite to a light-emitting member side of the light-emitting substrate.
